(19) United States
(12) Patent Application Publication
(10) Pub. No.: US 2022/0108219 A1
(43) Pub. Date: Apr. 7, 2022

(54) Approximate Bayesian Logistic Regression For Sparse Online Learning

(71) Applicant: Google LLC, Mountain View, CA (US)

(72) Inventors: Gil Shamir, Sewickley, PA (US); Wojciech Szpankowski, West Lafayette, IN (US)

(21) Appl. No.: 17/492,046

(22) Filed: Oct. 1, 2021

Related U.S. Application Data
(60) Provisional application No. 63/115,874, filed on Nov. 19, 2020.
(60) Provisional application No. 63/086,927, filed on Oct. 2, 2020.

(51) Int. Cl. G06N 20/00; G06N 7/02

(52) U.S. Cl. CPC G06N 20/00; G06N 7/02

(57) ABSTRACT

Systems and methods leverage low complexity (e.g., linear overall, fixed per example) analytical approximations to perform machine learning problems such as, for example, the sparse online logistic regression problem. Unlike variational inference and other methods, the proposed systems and methods lead to analytical closed forms, lowering the practical number of computations. Further, unlike techniques used for dense features sets, such as Gaussian Mixtures, the proposed systems and methods allow for sparse problems with huge feature sets without increasing complexity. With the analytical closed forms, there is also no need for applying stochastic gradient methods on surrogate losses, and for tuning and balancing learning and regularization parameters of such methods.

### RELATED APPLICATIONS

This application claims priority to and the benefit of each of U.S. Provisional Patent Application No. 63/086,927 filed Oct. 2, 2020 and U.S. Provisional Patent Application No. 63/115,874 filed Nov. 19, 2020. Both of U.S. Provisional Patent Application No. 63/086,927 and U.S. Provisional Patent Application No. 63/115,874 are hereby incorporated by reference in their entirety for all purposes.

### FIELD

The present disclosure relates generally to machine learning. More particularly, the present disclosure relates to approximate Bayesian learning, for example, for logistic regression and/or probit regression in a sparse online setting.

### BACKGROUND

Logistic regression is the bread and butter of machine learning systems. Online methods for optimizing logistic regression are suboptimal, and as such are missing opportunities to improve predictions, especially in cases where the expedient learning of new features is beneficial. Additionally, predictions are typically used to produce point estimates, and lack accurate uncertainty information about the examples on which they predict. Such good estimates would benefit the system by allowing to utilize predictions better downstream. Many systems predict with a huge set of sparse features, out of which only a small set occurs in each example. Existing methods that try to approximate Bayesian inference are heavy, complex, and suboptimal. They are not well geared towards sparse problems,

In particular, theoretical results show that Bayesian methods can achieve lower bounds on regret for online logistic regression. In practice, however, such techniques may not be feasible especially if the feature set is very large. Various approximations that, for huge sparse feature sets, diminish the theoretical advantages, must be used. Often, such approximations apply stochastic gradient methods with parameters that must be tuned on some surrogate loss, defeating the theoretical nonparametric advantages of Bayesian methods. The surrogate loss is defined to approximate the mixture and requires techniques like Monte Carlo sampling that increase the number of computations per example, and are not feasible if one desires performance close to the theoretical limits, which would require thousands of samples to achieve.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform online learning of machine learning models that is computationally efficient even with extreme numbers of features. The method includes obtaining, by a computing system comprising one or more computing devices, a machine-learned model comprising a respective mean parameter value and a respective variance parameter value for each of a plurality of features. The method includes, for each of one or more online learning examples: receiving, by the computing system, a new online learning example having a plurality of values for the plurality of features; processing, by the computing system, the new online learning example with the machine-learned model to generate a prediction for the new online learning example; observing, by the computing system, an actual outcome associated with the new online learning example; and, for each feature for which the new online learning example has a non-zero value: determining, by the computing system, an approximate posterior for the feature conditioned on the actual outcome, wherein the approximate posterior approximates a posterior expressed as a prior of the feature multiplied by a likelihood marginalized on all other features with a self-excluding prior and normalized by the prediction, wherein the self-excluding prior comprises a marginal prior of all the other features combined together, wherein determining the approximate posterior comprises determining an updated mean parameter value for the feature and an updated variance parameter value for the feature.

Another example aspect of the present disclosure is directed to a computing system configured to perform learning of machine learning models that is computationally efficient even with extreme numbers of features. The computing system includes one or more processors and one or more non-transitory computer-readable media that collectively store instructions that, when executed by the one or more processors cause the one or more processors to perform operations. The operations include obtaining, by the computing system, a machine-learned model comprising one or more weights for each of a plurality of features. The operations include, for each of one or more learning examples: receiving, by the computing system, a learning example having a plurality of values for the plurality of features; processing, by the computing system, the learning example with the machine-learned model to generate a prediction for the learning example; accessing, by the computing system, a true label associated with the new learning example; and, for each feature for which the learning example has a non-zero value: determining, by the computing system, an approximate posterior for the feature conditioned on the actual outcome, wherein the approximate posterior approximates a posterior expressed as a prior of the feature multiplied by a likelihood marginalized on all other features with a self-excluding prior and normalized by the prediction, wherein the self-excluding prior comprises a marginal prior of all the other features combined together, wherein determining the approximate posterior comprises determining an updated mean parameter value for the feature and an updated variance parameter value for the feature.

Another example aspect of the present disclosure is directed to one or more non-transitory computer-readable media that collectively store instructions that, when executed by one or more processors cause the one or more processors to perform operations. The operations include obtaining a machine-learned model comprising a respective mean parameter value and a respective variance parameter value for each of a plurality of features. The operations include, for each of one or more marginalized Bayesian learning iterations: receiving a learning example having a plurality of values for the plurality of features; processing the learning example with the machine-learned model to generate a prediction for the learning example; accessing a true label associated with the new learning example; and, for each feature for which the learning example has a non-zero value: determining a probability of the true label as a function of an updated mean parameter value for the feature and shrunk as a function of a self-excluding variance of the feature; and solving a minimization of the probability of the true label to determine the updated mean parameter value for the feature and an updated variance parameter value for the feature.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart diagram of an example method to perform Bayesian learning according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

FIG. 3 provides an example algorithm for performing marginalized Bayesian Gaussian Approximation according to example embodiments of the present disclosure.

Reference numerals that are repeated across plural figures are intended to identify the same features in various implementations.

### DETAILED DESCRIPTION

### Overview

Generally, the present disclosure is directed to systems and methods that leverage low complexity (e.g., linear overall, fixed per example) analytical approximations to perform machine learning problems such as, for example, the sparse online logistic regression problem. Unlike variational inference and other methods, the proposed systems and methods lead to analytical closed forms, lowering the practical number of computations. Further, unlike techniques used for dense features sets, such as Gaussian Mixtures, the proposed systems and methods allow for sparse problems with huge feature sets without increasing complexity. With the analytical closed forms, there is also no need for applying stochastic gradient methods on surrogate losses, and for tuning and balancing learning and regularization parameters of such methods. Example empirical results obtained on synthetic data demonstrate superior performance by the proposed techniques related to more computationally involved methods. However, like such more computationally involved methods, the proposed techniques still reveal per feature and per example uncertainty measures.

In particular, the present disclosure demonstrates that it is sufficient to approximate the component of the posterior which will dominate at the horizon, matching it by a diagonal Gaussian approximation, but avoiding matching (a bound on) the full posterior, as done by Variational Bayesian Inference (VB) methods. While matching the posterior may lead to comparable performance, it brings unnecessary complexity to the real goal of preserving the effects of a good prior on the regret. Specifically, in an online setting, matching the full range of the posterior can lead to poor generalization and overfitting if matching tails is at the expense of important parts of the distribution. Unlike VB methods, that approximate an upper bound on the loss and apply expectation on the bound, example marginalization techniques described herein apply updates directly on the current approximate of the posterior. Instead of matching a multivariate distribution, as done for dense methods, example implementations leverage sparsity and diagonalization by marginalizing on all features except the one being updated.

The systems and methods of the present disclosure provide a number of technical effects and benefits. As one example, the present disclosure provides systems and methods that through proper marginalization and approximation with the proper prior are able to achieve regret as good as the possible regret lower bounds. The proposed systems and methods provide faster convergence and learning than existing methods and also give an uncertainty estimate which is better than existing ones and can be used for a variety of problems. One core concept embodied in example implementations described herein is to wisely leverage Bayesian mixtures and marginalization, where a feature is updated by marginalizing over all other features. The approximation gives very simple low-complexity updates that do not require heavy sampling and/or iterations. By obviating the need to perform heavy sampling and/or iterations, the proposed techniques reduce the consumption of computing resources such as processor usage, memory usage, network bandwidth usage, etc.

As another example technical effect, the proposed techniques can improve any online system that performs prediction and can also be used in many batch training approaches, to speed up convergence, and to minimize use of multiple epochs. The proposed techniques also both provide good uncertainty estimates and lower uncertainty relative to other techniques.

### Example Preliminaries

Let ρₜ(w) be the prior on the weights at round t, where we start by initializing some ρ₁(w). We will assume that ρ(⋅) is approximated by a diagonal covariance Gaussian, with means μ_{i,t} and variances σ_{i,t}² for component i at time t. If we restrict wᵢ∈[−B, B], a uniform prior over this interval or a normal prior with standard deviation proportional to B can be picked. (To approximate a Dirichlet-½ (a Beta-½ prior—which is known to be optimal for a single dimensional problem), 0-mean normal prior with variance 2π can be used.) Observing sparse xₜ, the prediction for yₜ is given by

pₜ [symbol] P(yₜ|xₜ)=∫_{w}p(yₜ|xₜ,w)ρₜ(w)dw [symbol] ∫_{w}pₜ(yₜ,w|xₜ)dw, (1)

where for binary logistic regression, the probability of the label given the example and weights is given by the Sigmoid of the label weighted dot product of the example and weights

$$p ( {y}_{t} \vert {x}_{t} , w ) {=}^{Δ} \frac{1}{1 + exp ( - {y}_{t} {x}_{t}^{𝒯} w )} {=}^{Δ} Sigma ( {y}_{t} {x}_{t}^{𝒯} w ) . \qquad ( 2 )$$

The expected prediction pₜ in (1) marginalizes out the weights w according to the prior ρₜ(⋅) from the joint probability of w and yₜ. The prediction pₜ is a function also of all prior pairs sequence {x^{t-1}, y^{t-1}} through the prior ρₜ(⋅). After observing yₜ, we try to match a (diagonal) posterior Q(⋅) to the weights that will equal the next round's prior

$${ρ}_{t + 1} ( w ) = Δ {Q}_{t} ( w ) \approx p ( w \vert {x}^{t} , {y}^{t} ) = \frac{p ( {y}_{t} \vert {x}_{t} , w ) {ρ}_{t} ( w )}{P ( {y}_{t} \vert {x}_{t} )} = \frac{p ( {y}_{t} \vert {x}_{t} , w ) {ρ}_{t} ( w )}{{p}_{t}} . \qquad ( 3 )$$

Using S_{T} [symbol] {x^{T}, y^{T}}, the logarithmic loss incurred by approximation Q(⋅) on the sequence of predictions is L(S_{T}, Q) [symbol] Σₜ₌₁^{T} log pₜ. Let w* be some fixed comparator in the parameter values' space. Then, the regret of approximation Q(⋅) relative to comparator w* is given by

R(S_{T},Q,w*) [symbol] L(S_{T},Q)−L(S_{T},w*)=−Σₜ₌₁^{T}[log pₜ+log(1+exp(−yₜxₜ [symbol] w*)]. (4)

The regret can measure the excess loss relative to the best possible w* comparator, if it is chosen.

### Example Marginalized Bayesian Gaussian Approximation

This section describes example, non-limiting implementations of the proposed method. In some implementations, first, the Sigmoid is approximated by a normal Cumulative Distribution Function (CDF). A prediction for the label of the current example is generated shrinking the cumulative mean score as function of the cumulative variance over all features. The main idea for updating feature distributions is marginalizing away all other covariates for each feature in an example at a given round, such that the mean and variance of the feature can be updated to match the location of the peak and either its curvature or value to the true marginalized posterior. An example approach for Probit Regression can follow the same steps, except that it does not require the initial approximation. Similar approximation methodology can be used to apply simple multi-dimensional updates instead of a marginalized one, and can be performed when sparsity is limited.

Gaussian Approximation of a Sigmoid: The relation between the logistic distribution and the Normal one was well studied in the statistics literature. The Sigmoid function in (2) can be viewed as a CDF, which can be approximated by a normal CDF Φ(z) (The inverse of Φ(⋅) is the Probit function.) The derivative of the Sigmoid function is the 0-mean Logistic Probability Density Function (PDF). Matching the PDFs, we have e^{w}/(1+e^{w})²≈1/\sqrt{2πσ²}exp{−w²/2σ²}. This yields that the Sigmoid function can be approximated by a 0-mean Gaussian CDF with variance 8/π. Using the standard 0-mean normal Φ(⋅) function, the argument is scaled by the inverse of the standard deviation \sqrt{π/8}, giving

$$Sigma ( w ) = Δ \frac{1}{1 + {e}^{- w}} \approx Φ ( \sqrt{\frac{π}{8}} \cdot w ) . \qquad ( 5 )$$

Approximation approach and some notation: With the diagonal and Gaussian assumptions, for each sparse example (with only dₜ<<d nonzero entries in xₜ), we can assume that we have a single normal random variable, whose mean is the xₜ weighted mean of covariate weights, and whose variance is the quadratically weighted sum of variances. Denote the example total weight, mean, and variance by

wₜ [symbol] Σᵢ₌₁^{d}x_{i,t}w_{i,t},μₜ [symbol] Σᵢ₌₁^{d}x_{i,t}·μ_{i,t},σₜ² [symbol] Σᵢ₌₁^{d}x_{i,t}²·σ_{i,t}² (6)

(where the diagonalization assumption is important for the simplicity of the approximation of σₜ²).

Since we consider a sparse problem, there is benefit to breaking the dependencies between features present in a given example and updating each independently. We can achieve that by marginalizing the prior at t over all other features. Because we assume all features are jointly independent Gaussians, we can break the joint prior into a product of two components; one, the marginal of the feature, and the other the marginal of all other features together, i.e., the self excluding prior. To match the posterior, we then marginalize on the latter, and match a single dimensional posterior for each feature. We define the self excluding prior for feature i at time t, its mean and variance as

$${w}_{- i , t} = {\sum }_{j = 1}^{d} {x}_{j , t} {w}_{j , t} - {x}_{i , t} {w}_{i , t} = {\sum }_{j \neq i} {x}_{j , t} {w}_{j , t} ; \\ {μ}_{- i , t} {=}^{Δ} {μ}_{t} - {x}_{i , t} {μ}_{i , t} ; \\ {σ}_{- i , t}^{2} {=}^{Δ} {σ}_{t}^{2} - {x}_{i , t}^{2} {σ}_{i , t}^{2} \qquad ( 7 )$$

Prediction: With the probit approximation in (5) and the single dimensional variable wₜ, we can compute pₜ in (1), replacing p(yₜ|xₜ,w) in (2) by a normal CDF. Approximating this integral (see, e.g. [Murphy(2012)], Section 8.4.4.2, and [Bishop(2006)]) gives

$${p}_{t} \approx Sigma ( \frac{{y}_{t} {μ}_{t}}{\sqrt{1 + \frac{π}{8} {σ}_{t}^{2}}} ) . \qquad ( 8 )$$

This result demonstrates how the prediction variance shrinks the prediction towards probability 0.5.

Marginalization: Given the diagonalization assumption, the prior at t can be expressed as ρₜ(w)=ρ_{i,t}(wᵢ)·ρ_{-i,t}(w₋ᵢ), where ρ_{-i,t}(⋅) is the prior on the self excluding prior of wᵢ. Hence,

p(yₜ,w|xₜ)=p(yₜ|xₜ,w)ρ_{i,t}(wᵢ)ρ_{-i,t}(w₋ᵢ). (9)

Marginalizing on w₋ᵢ gives

p(yₜ,wᵢ|xₜ)=ρ_{i,t}(wᵢ)∫_{-∞}^{∞}(yₜ|xₜ,w)ρ_{-i,t}(w₋ᵢ)dw₋ᵢ [symbol] ρ_{i,t}(wᵢ)I_{W}_{_{−i}}_{,t}. (10)

The inner integral, which marginalizes over w₋ᵢ with its prior ρ_{-i,t}(w₋ᵢ), can be approximated by

$${I}_{{w}_{- i} , t} = {\int }_{- ∞}^{∞} \frac{1}{\sqrt{2 π {σ}_{- i , t}^{2}}} exp ( - \frac{{( {w}_{- i} - {μ}_{- i , t} )}^{2}}{2 {σ}_{- i , t}^{2}} ) \cdot Sigma [ {y}_{t} ( {x}_{i , t} {w}_{i} + {w}_{- i} ) ] d {w}_{- i} {\approx }^{( a )} {\int }_{- ∞}^{∞} \frac{1}{\sqrt{2 π {σ}_{- i , t}^{2}}} exp ( - \frac{{( {w}_{- i} - {μ}_{- i , t} )}^{2}}{2 {σ}_{- i , t}^{2}} ) \cdot Φ [ \sqrt{\frac{π}{8}} {y}_{t} ( {x}_{i , t} {w}_{i} + {w}_{- i} ) ] d {w}_{- i} {=}^{( b )} {\int }_{- ∞}^{∞} ϕ ( z ) \cdot Φ [ \sqrt{\frac{π}{8}} {y}_{t} ( {x}_{i , t} {w}_{i} + {μ}_{- i , t} + {σ}_{- i , t} z ) ] dz {=}^{( c )} Φ ( \frac{\sqrt{\frac{π}{8}} {y}_{t} ( {μ}_{- i , t} + {x}_{i , t} {w}_{i} )}{\sqrt{1 + \frac{π}{8} {σ}_{- i , t}^{2}}} ) {\approx }^{( d )} Sigma ( \frac{{y}_{t} ( {μ}_{- i , t} + {x}_{i , t} {w}_{i} )}{\sqrt{1 + \frac{π}{8} {σ}_{- i , t}^{2}}} ) . \qquad ( 11 )$$

Step (a) follows, again, from the approximation in (5). For (b), we apply the change of variables z=(w₋ᵢ−μ_{-i,t})/σ_{-i,t}, where ϕ(⋅) is the standard Gaussian PDF. The integral in (b) gives

$$Φ ( \frac{a}{\sqrt{1 + {b}^{2}}} ) ,$$

with

$$a = \sqrt{\frac{π}{8}} {y}_{t} ( {μ}_{- i , t} + {x}_{i , t} {w}_{i} )$$

$$and$$

$${b}^{2} = \frac{π}{8} {σ}_{- i , t}^{2}$$

to lead to (c). Finally, the approximation in (5) is used to go back from a Normal CDF to a Sigmoid in (d).

Posterior: The posterior on wᵢ is given by plugging (11) into (10) normalizing by pₜ given in (1).

$${ρ}_{i , t + 1} ( {w}_{i} ) = {Q}_{i , t} ( {w}_{i} ) \approx p ( {w}_{i} \vert {x}^{t} , {y}^{t} ) = \frac{1}{{p}_{t}} \cdot {ρ}_{i , t} ( {w}_{i} ) \cdot Sigma ( \frac{{y}_{t} ( {μ}_{- i , t} + {x}_{i , t} {w}_{i} )}{\sqrt{1 + \frac{π}{8} {σ}_{- i , t}^{2}}} ) . \qquad ( 12 )$$

The approximation on the right implies matching the current true posterior with the ith component of the approximate posterior Q(⋅). It can be simplified to

$$\frac{1}{{σ}_{i , t + 1}} exp ( - \frac{{( {w}_{i} - {μ}_{i , t + 1} )}^{2}}{2 {σ}_{i , t + 1}^{2}} ) \approx \frac{1}{{p}_{t} {σ}_{i , t}} exp ( - \frac{{( {w}_{i} - {μ}_{i , t} )}^{2}}{2 {σ}_{i , t}^{2}} ) \cdot Sigma ( \frac{{y}_{t} ( {μ}_{- i , t} + {x}_{i , t} {w}_{i} )}{\sqrt{1 + \frac{π}{8} {σ}_{- i , t}^{2}}} ) . \qquad ( 13 )$$

Approximations: Because the functional form of the posterior is not Gaussian, there are multiple ways to fit a Gaussian. However, we want to ensure that the regions of the true posterior we are most likely to converge to at the horizon are not scaled down too much, as this will incur additional loss. It is thus desirable to match the peak of the true posterior with the peak of the approximation. One method is to match both the location and height of the peak. The other, Laplace approximation, matches the location and curvature at the peak. Both methods give the same approximate for μ_{i,t+1}, but a somewhat different one for σ_{i,t+1}².

To give μ_{i,t+1}, we find wᵢ that maximizes the r.h.s. of (13), or minimizes its negative logarithm. Let

$${p}_{i , t +} {=}^{Δ} Sigma ( \frac{{y}_{t} ( {μ}_{- i , t} + {x}_{i , t} {μ}_{i , t + 1} )}{\sqrt{1 + \frac{π}{8} {σ}_{- i , t}^{2}}} ) = {[ 1 + exp ( - \frac{{y}_{t} ( {μ}_{- i , t} + {x}_{i , t} {μ}_{i , t + 1} )}{\sqrt{1 + \frac{π}{8} {σ}_{- i , t}^{2}}} ) ]}^{- 1} \qquad ( 14 )$$

be almost pₜ in (8), except that μ_{i,t+1} replaces μ_{i,t} and σ_{-i,t}² replaces σₜ². Thus p_{i,t+} is the probability predicted for yₜ if we update μ_{i,t} and shrink as function of σ_{-i,t}². The minimization gives

$${μ}_{i , t + 1} = {μ}_{i , t} + \frac{{y}_{t} {x}_{i , t} {σ}_{i , t}^{2}}{\sqrt{1 + \frac{π}{8} {σ}_{- i , t}^{2}}} \cdot ( 1 - {p}_{i , t +} ) . \qquad ( 15 )$$

Eq. (15) can be solved iteratively, where Newton's method can be used. The solution for μ_{i,t+1} can also be expressed in terms of the r generalized Lambert W function [Corless et˜al. (1996) Corless, Gonnet, Hare, Jeffrey, and Knuth, Mezo Baricz (2015) Mezo and Baricz].

Alternatively, to avoid multiple iterations per update when using Newton's method, we can use a Taylor series approximation of 1−p_{i,t+} around 1−p_{i,t}, where

$${p}_{i , t} {=}^{Δ} Sigma ( \frac{{y}_{t} ( {μ}_{- i , t} + {x}_{i , t} {μ}_{i , t} )}{\sqrt{1 + \frac{π}{8} {σ}_{- i , t}^{2}}} ) = Sigma ( \frac{{y}_{t} {μ}_{t}}{\sqrt{1 + \frac{π}{8} {σ}_{- i , t}^{2}}} ) . \qquad ( 16 )$$

Like p_{i,t+}, p_{i,t} is not pₜ. Instead, it is the probability of yₜ as projected by the means of the weights at t, shrunk as function of σ_{-i,t}² instead of σₜ². More importantly, it depends only on parameters before the update at t+1 is applied, giving a closed form solution. Applying first order approximation we have

$${μ}_{i , t + 1} = {μ}_{i , t} + \frac{{y}_{t} {x}_{i , t} {σ}_{i , t}^{2} ( 1 - {p}_{i , t} )}{\sqrt{1 + \frac{π}{8} {σ}_{- i , t}^{2}} [ 1 + \frac{1}{1 + \frac{π}{8} {σ}_{- i , t}^{2}} {y}_{t}^{2} {x}_{i , t}^{2} {σ}_{i , t}^{2} ( 1 - {p}_{i , t} ) {p}_{i , t} ]} . \qquad ( 17 )$$

If may be simpler to store the precision 1/σ_{i,t}², in which case, (17) may be easier to compute by normalizing both numerator and denominator by σ_{i,t}², applying this normalization on the right term of the denominator. Second or higher orders approximations can also be applied, but may not be necessary, as the first order one already gives identical performance to the iterative method.

After updating μ_{i,t+1}, we can apply (13) to update σ_{i,t+1}. Plugging (15) in (13), we solve for σ_{i,t+1},

$${σ}_{i , t + 1} = \frac{{p}_{t} {σ}_{i , t}}{{p}_{i , t +}} \cdot exp \{ \frac{{( {μ}_{i , t + 1} - {μ}_{i , t} )}^{2}}{2 {σ}_{i , t}^{2}} \} = \frac{{p}_{t} {σ}_{i , t}}{{p}_{i , t +}} \cdot exp \{ \frac{{y}_{t}^{2} {x}_{i , t}^{2} {σ}_{i , t}^{2}}{2 ( 1 + \frac{π}{8} {σ}_{- i , t}^{2} )} \cdot {( 1 - {p}_{i , t +} )}^{2} \} . \qquad ( 18 )$$

Alternatively to (18), Laplace approximation can be used by finding the second derivative of the negative logarithm of the posterior, giving

$${σ}_{i , t + 1}^{2} = {[ \frac{1}{{σ}_{i , t}^{2}} + \frac{{y}_{t}^{2} {x}_{i , t}^{2}}{1 + \frac{π}{8} {σ}_{- i , t}^{2}} \cdot {p}_{i , t +} \cdot ( 1 - {p}_{i , t +} ) ]}^{- 1} . \qquad ( 19 )$$

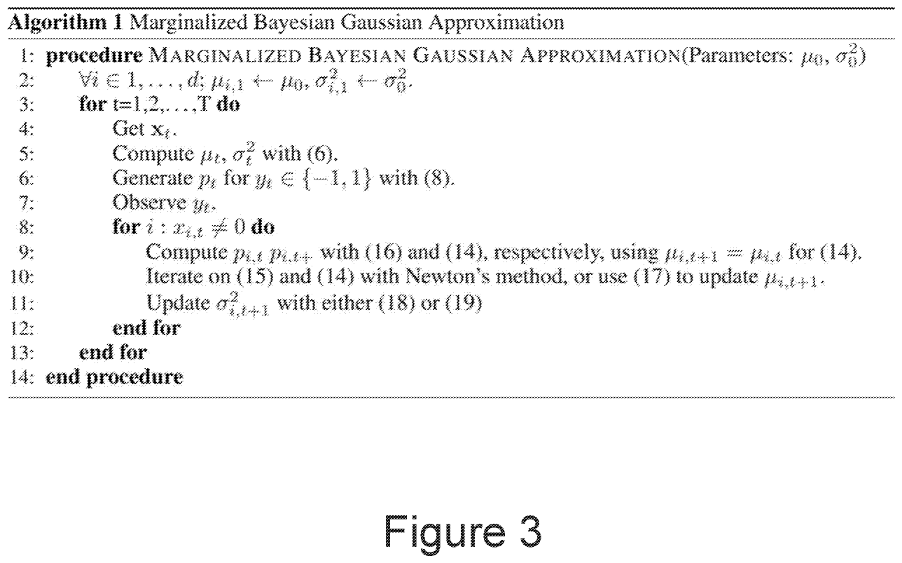

An example implementation of the procedures described is summarized in Algorithm 1, reproduced below and also in FIG. 3.

Algorithm 1 Marginalized Bayesian Gaussian Approximation

| | |
|---|---|
| 1: | procedure MARGINALIZED BAYESIAN GAUSSIAN APPROXIMATION(Parameters: μ₀, σ₀²) |

| | |
|---|---|
| 2: | ∀i ϵ 1,..., d; μ_{i, 1} ← μ₀, σ_{i, 1}² ← σ₀². |
| 3: | for t=1,2,...,T do |

| | |
|---|---|
| 4: | Get xₜ. |
| 5: | Compute μₜ, σₜ² with (6). |
| 6: | Generate pₜ for yₜ ϵ {−1, 1} with (8). |
| 7: | Observe yₜ. |
| 8: | for i : x_{i,t} ≠ 0 do |

| | |
|---|---|
| 9: | Compute p_{i,t} p_{i,t+} with (16) and (14), respectively, using μ_{i,t+1} = μ_{i,t} for (14). |
| 10: | Iterate on (15) and (14) with Newton's method, or use (17) to update μ_{i,t+1}. |
| 11: | Update σ_{i,t+1}² with either (18) or (19) |

| | |
|---|---|
| 12: | end for |

| | |
|---|---|
| 13: | end for |

| | |
|---|---|
| 14: | end procedure |

### Example Relation Between Gaussian and Sigmoid

The Sigmoid function, which converts log-odds to probability is very close in shape to the Gaussian Cumulative Distribution Function (CDF) Φ(z), as well established in the statistics literature. The derivative of the Sigmoid function is given by

$$\frac{d Sigma ( w )}{d w} = \frac{{e}^{w}}{{( 1 + {e}^{w} )}^{2}} \qquad ( 20 )$$

and equals the PDF of a 0-mean Logistic distribution. We can approximate the logistic PDF by a Gaussian by matching the PDFs,

$$\frac{{e}^{w}}{{( 1 + {e}^{w} )}^{2}} \approx \frac{1}{\sqrt{2 π} σ} exp \{ - \frac{{w}^{2}}{2 {σ}^{2}} \} . \qquad ( 21 )$$

Matching the distributions at w=0 yields σ=\sqrt{8/π},

$$\frac{{e}^{w}}{{( 1 + {e}^{w} )}^{2}} \approx \frac{1}{4} exp \{ - \frac{π {w}^{2}}{16} \} = \sqrt{\frac{π}{8}} \cdot \frac{1}{\sqrt{2 π}} exp \{ - \frac{{w}^{2}}{2 \cdot \frac{8}{π}} \} . \qquad ( 22 )$$

Thus, we can approximate the Sigmoid with a 0-mean Gaussian CDF with variance 8/π, giving (5).

### Example Probit Regression

In this section, we show the derivation of the method proposed in this paper for Probit Regression, where, in a similar manner to (2), the predicted label probability with weight vector w, label yₜ, and covariates xₜ is given by the normal CDF

$$p ( {y}_{t} \vert {x}_{t} , w ) {=}^{Δ} {\int }_{- ∞}^{{y}_{t} {x}_{t}^{𝒯} w} \frac{1}{\sqrt{2 π}} exp ( - \frac{{α}^{2}}{2} ) d α {=}^{Δ} {\int }_{- ∞}^{{y}_{t} {x}_{t}^{𝒯} w} ϕ ( α ) d α {=}^{Δ} Φ ( {y}_{t} {x}_{r}^{𝒯} w ) \qquad ( 23 )$$

where, as we recall, ϕ(⋅) and Φ(⋅) are the standard Gaussian (normal) PDF and CDF, respectively. While for logistic regression, we used a Gaussian approximation to obtain analytical expressions for the prediction in (8) and the marginalization integral in (11), for probit regression, these are no longer approximations. For the posterior, we will still apply a Gaussian and a diagonal approximations, as in the derivations based on (13).

Prediction: The approach for probit regression is similar to the one described in Section 3 for logistic regression. For each feature we track the mean μ_{i,t} and the variance σ_{i,t}² for the ith feature. For example t, we use (6) to compute the total weight wₜ, its mean μₜ and variance σₜ². Eq. (7) gives the self excluding weights, their means, and their variances. Similarly to (8), using the approximate normal prior at t, we can derive the label prediction for yₜ,

$${p}_{t} = P ( {y}_{t} \vert {x}_{t} ) = {\int }_{- ∞}^{∞} \frac{1}{\sqrt{2 π {σ}_{t}^{2}}} \cdot exp \{ - \frac{{( {w}_{t} - {μ}_{t} )}^{2}}{2 {σ}_{t}^{2}} \} \cdot Φ ( {y}_{t} {x}_{t}^{𝒯} w ) \cdot {dw}_{t} {=}^{( a )} {\int }_{- ∞}^{∞} \frac{1}{\sqrt{2 π {σ}_{t}^{2}}} \cdot exp \{ - \frac{{( {w}_{t} - {μ}_{t} )}^{2}}{2 {σ}_{t}^{2}} \} \cdot {\int }_{- ∞}^{{y}_{t} {w}_{t}} \frac{1}{\sqrt{2 π}} exp ( - \frac{{z}^{2}}{2} ) \cdot dz \cdot {dw}_{t} {=}^{( b )} {\int }_{- ∞}^{∞} \frac{1}{\sqrt{2 π}} \cdot exp \{ - \frac{{v}^{2}}{2} \} \cdot {\int }_{- ∞}^{{y}_{t} ( {σ}_{t} v + {μ}_{t} )} \frac{1}{\sqrt{2 π}} exp ( - \frac{{z}^{2}}{2} ) \cdot dz \cdot dv {=}^{( c )} {\int }_{- ∞}^{∞} ϕ ( v ) \cdot Φ [ {y}_{t} ( {σ}_{t} v + {μ}_{t} ) ] dv {=}^{( d )} Φ ( \frac{{y}_{t} {μ}_{t}}{\sqrt{1 + {σ}_{t}^{2}}} ) . \qquad ( 24 )$$

For (a), we use the definition of wₜ in (6). Step (b) follows from substituting v=(wₜ−μₜ)/σₜ. Step (c) identified the integrands as a product of the standardized N(0,1) normal PDF multiplied by a standardized normal CDF at yₜ(σₜv+μₜ). This integral gives a normal

$$CDF Φ ( \frac{a}{\sqrt{1 + {b}^{2}}} )$$

for a=yₜμₜ and b²=yₜ²σₜ²=σₜ² at leading to (d).

Marginalization: Following the marginalization steps described herein, we can express the joint probability of weight wₜ and label yₜ conditioned on the covariates xₜ and marginalized over all the other nonzero covariates at example t as in (10) by

$$P ( {y}_{t} , {w}_{i} \vert {x}_{t} ) = {ρ}_{i , t} ( {w}_{i} ) \cdot Φ ( \frac{{y}_{t} ( {μ}_{- i , t} + {x}_{i , t} {w}_{i} )}{\sqrt{1 + {σ}_{- i , t}^{2}}} ) \qquad ( 22 )$$

where we use the steps of (11), excluding the approximations, to derive (25).

Posterior: The posterior on wₜ is given as in (12), normalizing p (yₜ, wᵢ|xₜ) by pₜ from (24).

$${ρ}_{i , t + 1} ( {w}_{i} ) \approx p ( {w}_{i} \vert {x}^{t} , {y}^{t} ) = \frac{1}{{p}_{t}} \cdot {ρ}_{i , t} ( {w}_{i} ) \cdot Φ ( \frac{{y}_{t} ( {μ}_{- i , t} + {x}_{i , t} {w}_{i} )}{\sqrt{1 + {σ}_{- i , t}^{2}}} ) . \qquad ( 26 )$$

This posterior can now be matched by a normal posterior Q_{t,t}(wᵢ) as in (13).

Approximation: Here, we follow the Laplace approximation applied in Section 3. All other methods mentioned in the paper are also possible. To find μ_{i,t+1} that minimizes the negative logarithm of the r.h.s. of (26), define, similarly to (14),

$${z}_{i , t +} {=}^{Δ} \frac{{y}_{t} ( {μ}_{- i , t} + {x}_{i , t} {μ}_{i , t + 1} )}{\sqrt{1 + {σ}_{- i , t}^{2}}} \qquad ( 27 )$$

as the probit score, which serves as the argument of the normal CDF, where the ith mean has been updated, but all other means have not. We can now express the update of the ith mean by

$${μ}_{i , t + 1} = {μ}_{i , t} + \frac{{y}_{t} {x}_{i , t} {σ}_{i , t}^{2}}{\sqrt{1 + {σ}_{- i , t}^{2}}} \cdot \frac{ϕ ( {z}_{i , t +} )}{Φ ( {z}_{i , t +} )} . \qquad ( 28 )$$

Eq. (28) is a similar update for probit regression to that of (15) for logistic regression, where the ratio ϕ(z_{i,t+})/Φ(z_{i,t+}) replaces 1−p_{i,t+} (and the scaling of the self excluding variance is unnecessary).

As (15), (28) must be solved iteratively because the term ϕ(z_{i,t+})/Φ(z_{i,t+}) is a function of μ_{i,t+1} through the definition of z_{i,t+}. As in Section 3, we can use a first order Taylor approximation of ϕ(z_{i,t+})/Φ(z_{i,t+}) around its value for μ_{i,t}. Similarly to (16), we define

$${z}_{i , t} {=}^{Δ} \frac{{y}_{t} ( {μ}_{- i , t} + {x}_{i , t} {μ}_{i , t} )}{\sqrt{1 + {σ}_{- i , t}^{2}}} \qquad ( 29 )$$

which is the score before update of all means μ_{i,t}, but unlike the one used to compute pₜ, normalized by the ith self excluding variance σ_{-i,t}² instead of σₜ². With some algebra, this gives a single operation update, similar to that in (17), given by

$${μ}_{i , 1 + 1} = {μ}_{i , t} + \frac{{y}_{t} {x}_{i , t} {σ}_{i , t}^{2} ϕ ( {z}_{i , t} ) / Φ ( {z}_{i , t} )}{\sqrt{1 + {σ}_{- i , t}^{2}} \{ 1 + \frac{1}{1 + {σ}_{- i , t}^{2}} {y}_{t}^{2} {x}_{i , t}^{2} {σ}_{i , t}^{2} \cdot \frac{ϕ ( {z}_{i , t} )}{Φ ( {z}_{i , t} )} \cdot [ {z}_{i , t} + \frac{ϕ ( {z}_{i , t} )}{Φ ( {z}_{i , t} )} ] \}} . \qquad ( 30 )$$

The term z_{i,t}+ϕ(z_{i,t})/Φ(z_{i,t}) in the denominator replaces p_{i,t} in the logistic regression update equation.

Taking the second derivative of the negative logarithm of the posterior and approximating 1/σ_{i,t+1}² by it, gives a single operation update of the variance, similarly to (19),

$${σ}_{i , t + 1}^{2} = {\{ \frac{1}{{σ}_{i , t}^{2}} + \frac{{y}_{t}^{2} {x}_{i , t}^{2}}{1 + {σ}_{- i , t}^{2}} \cdot \frac{ϕ ( {z}_{i , t +} )}{Φ ( {z}_{i , t +} )} \cdot [ {z}_{i , t +} + \frac{ϕ ( {z}_{i , t +} )}{Φ ( {z}_{i , t +} )} ] \}}^{- 1} . \qquad ( 31 )$$

### Example Multi-Dimensional Gaussian Approximation

Instead of marginalizing on all other features to update wᵢ for which x_{i,t}≠0, we can apply multi-dimensional update on all features for which x_{i,t}≠0 at round t. Such updates will enhance correlation between these features, and may be a better fit to problems in which such correlation is expected. For this update, we assume that the true posterior consists of a product between a prior with a diagonal covariance matrix and a Sigmoid, and we apply Lapace approximation to obtain new mean vector and covariance. With some abuse of notation, let all values at t consist only of the dₜ nonzero components of xₜ. Let Σₜ be the diagonal covariance matrix, with diagonal elements σ_{i,t}². Let uₜ be the estimated mean vector at t. Then, the true posterior at t is given by

$$p ( w \vert {x}^{t} , {y}^{t} ) = \frac{1}{{p}_{t}} \cdot \frac{exp \{ - \frac{1}{2} {( w - {u}_{t} )}^{𝒯} {\sum }_{t}^{- 1} ( w - {u}_{t} ) \}}{\sqrt{{( 2 π )}^{{d}_{t}} \vert {\sum }_{t} \vert}} \cdot \frac{1}{1 + exp \{ - {y}_{t} {x}_{t}^{𝒯} w \}} \qquad ( 35 )$$

Similarly to (14), define

pₜ₊ [symbol] Sigma( [symbol] uₜ₊₁) (36)

as the probability of yₜ computed with weights after they had been updated (and this time with no shrinkage), where uₜ₊₁ is the updated vector of means. Then, with Laplace approximation, taking the value of the mean vector that maximizes the posterior, the mean can be updated as in (15) by

uₜ₊₁=uₜ+Σₜyₜxₜ(1−pₜ₊). (37)

This is, again, an equation that must be solved either numerically, or using methods such as Newton's method. Again, we can assign uₜ₊₁⁽⁰⁾=uₜ, and apply (36) on it to obtain pₜ₊⁽⁰⁾. Then, at iteration [symbol] ,

[symbol]

=Σₜ⁻¹( [symbol] −uₜ)−yₜxₜ·(1− [symbol] ) (38)

and

[symbol]

=Σₜ⁻¹+yₜ²xₜ [symbol] · [symbol] ·(1− [symbol] ). (39)

Then, uₜ₊₁ is updated by

[symbol]

= [symbol] − [symbol] . (40)

Termination is either when the update on all components of uₜ₊₁ is less than some threshold, or after a set number of iterations. Inverting the Hessian H also gives the updated covariance Σₜ₊₁, whose diagonal elements can be now used to update σ_{i,t+1}², if we apply the algorithm for a sparse problem, where it is infeasible to store all covariances.

Instead of updating [symbol] , we can keep track of its inverse [symbol] , and there is no need to invert the covariance matrix Σₜ. With the diagonal form of Σₜ, all operations can be implemented with linear complexity in dₜ using the [Sherman Morrison (1950) Sherman and Morrison] formula, which simplifies matrix inversions for special matrices. For our specific need here, if A is some matrix, α some constant, and x some vector, then, the Sherman-Morrison formula is

$${( A + α x {x}^{𝒯} )}^{- 1} = {A}^{- 1} - \frac{{A}^{- 1} α x {x}^{𝒯} {A}^{- 1}}{1 + α {x}^{𝒯} {A}^{- 1} x} . \qquad ( 41 )$$

Substituting A=Σₜ⁻¹, x=xₜ, and α= [symbol] (1− [symbol] ), we update [symbol] , inverting (39).

As in the marginalization method described in Section 3, we can avoid the iterative Newton method with a first order Taylor approximation of 1−pₜ₊ around 1−\tilde{p}ₜ, where \tilde{p}ₜ is defined in an analogy to (16) as

\tilde{p}ₜ [symbol] Sigma( [symbol] ) (42)

as the un-shrunk prediction of yₜ at round t (which is different from pₜ, which is shrunk by the variance). The approximation leads to the following set of equations to update both uₜ₊₁ and Σₜ₊₁. For simplification, define

vₜ=Σₜxₜ. (43)

Then, temporarily update Σₜ, using Sherman-Morrison formula, to

$${\tilde{\sum }}_{t + 1} = {\sum }_{t} - \frac{{y}_{t}^{2} {\tilde{p}}_{t} ( 1 - {\tilde{p}}_{t} ) {\sum }_{t} {x}_{t} {x}_{t}^{𝒯} {\sum }_{t}^{𝒯}}{1 + {y}_{t}^{2} {\tilde{p}}_{t} ( 1 - {\tilde{p}}_{t} ) {x}_{t}^{𝒯} {\sum }_{t} {x}_{t}} = {\sum }_{t} - \frac{{y}_{t}^{2} {\tilde{p}}_{t} ( 1 - {\tilde{p}}_{t} ) {v}_{t} {v}_{t}^{𝒯}}{1 + {y}_{t}^{2} {\tilde{p}}_{t} ( 1 - {\tilde{p}}_{t} ) {x}_{t}^{𝒯} {v}_{t}} . \qquad ( 44 )$$

Since Σₜ is diagonal, the transpose on the last term of the numerator in the first equality is unnecessary. The second equality gives vector multiplications, showing that the complexity is linear in the dimension of the vectors dₜ. (This is true also to the computation of vₜ when Σₜ is diagonal.) Next, uₜ₊₁ can be updated

uₜ₊₁=uₜ+yₜ(1−\tilde{p}ₜ)\tilde{Σ}ₜ₊₁xₜ. (45)

Now, we can update pₜ₊ in (36), using uₜ₊₁, and use it to update Σₜ₊₁ using Sherman-Morrison,

$${\sum }_{t + 1} = {\sum }_{t} - \frac{{y}_{t}^{2} {p}_{t +} ( 1 - {p}_{t +} ) {v}_{t} {v}_{t}^{𝒯}}{1 + {y}_{t}^{2} {p}_{t +} ( 1 - {p}_{t +} ) {x}_{t}^{𝒯} {v}_{t}} . \qquad ( 46 )$$

In the sparse case, we can now take the terms of the diagonal of Σₜ₊₁ to update σ_{i,t+1}² of the nonzero covariates at round t.

Finally, it may be simpler to update the precision matrix Hₜ₊₁=Σₜ₊₁⁻¹ instead of the covariance Σₜ₊₁. Specifically, if multiple updates are performed in a mini batch, the update applied to the covariance cannot be applied additively. However, additive updates on the precision are valid. Thus the updates in (44) and (46) can be replaced by

\tilde{H}ₜ₊₁=Hₜ+yₜ²\tilde{p}ₜ(1−\tilde{p}ₜ) [symbol] (47)

and

Hₜ₊₁=Hₜ+yₜ²pₜ₊(1−pₜ₊) [symbol] (48)

respectively. To update uₜ₊₁, we still need to invert \tilde{H}ₜ₊₁. We can use (44) if an update was applied to a single round only. If a mini-batch update additively applied multiple updates at once in (47), the updated \tilde{H}ₜ₊₁ must be inverted to obtain \tilde{Σ}ₜ₊₁.

The multi-dimensional approach described in this section can be applied to sparse problems, but also to dense problems. In the dense case, the operation in (43) is no longer linear in dₜ, as the covariance matrix is not necessarily diagonal. The use of Sherman-Morrison formula, however, to invert the precision and covariance, still applies and lowers the complexity of the approach. In the sparse problem, however, this approach may try to force correlations that are not there, that are then ignored. As empirical results suggest, it may not be as good as the marginalization approach because of that. Furthermore, unlike other marginalization approaches described herein, which achieve best performance if the true prior matches the one used to initialize the algorithm, empirical results demonstrate that the best performances are obtained with priors that are different from the true one with the multi-dimensional method when applied on sparse problems.

### Example Methods

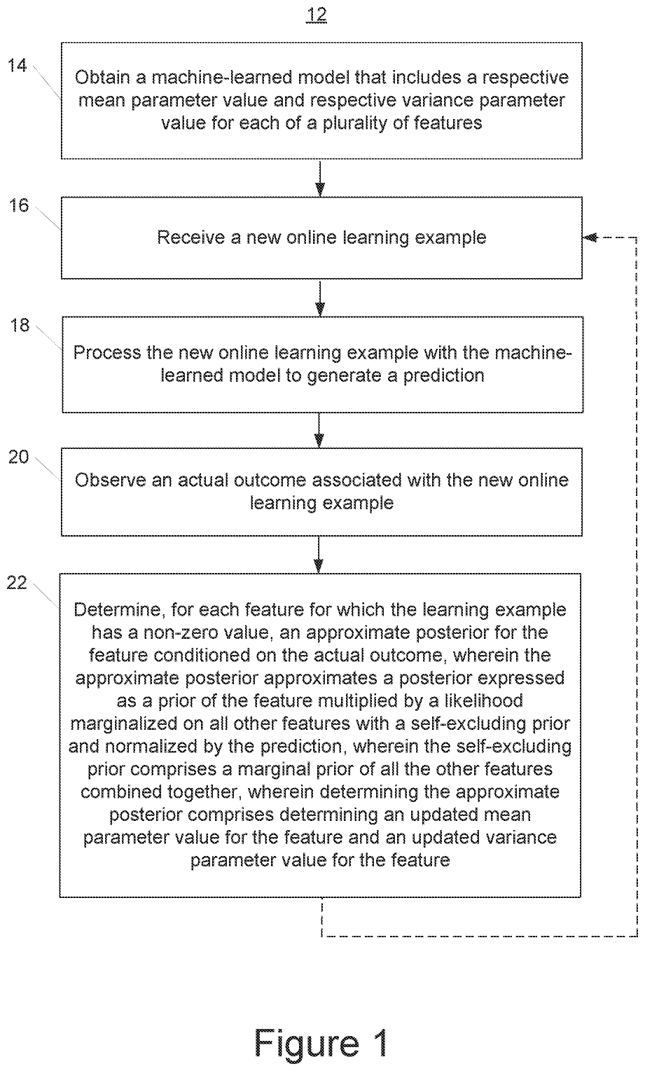

FIG. 1 depicts a flow chart diagram of an example method 12 to perform Bayesian optimization according to example embodiments of the present disclosure. Although FIG. 1 depicts steps performed in a particular order for purposes of illustration and discussion, the methods of the present disclosure are not limited to the particularly illustrated order or arrangement. The various steps of the method 12 can be omitted, rearranged, combined, and/or adapted in various ways without deviating from the scope of the present disclosure.

Method 12 can begin at Block 14. Block 14 can include obtaining, by a computing system comprising one or more computing devices, a machine-learned model comprising a respective mean parameter value and a respective variance parameter value for each of a plurality of features.

In some implementations, the machine-learned model is or includes a regression model such as, for example, a logistic regression model such as, for example, a binary logistic regression model. In some implementations, the machine-learned model is or includes a wide and deep model (see, e.g., Cheng et al., Wide & Deep Learning for Recommender Systems, arxiv: 1606.07792).

In some implementations, a number of the plurality of features exceeds one billion.

Block 16 can include receiving, by the computing system, a new online learning example having a plurality of values for the plurality of features.

In some implementations, the new online learning example is sparse in the plurality of features. In other implementations, sparseness is not limited and similar dense updates are provided. For example, a dense update without marginalization can be used over the other features, but with the same approximations leading to either a Newton method solution or a closed form solution for the updates.

Block 18 can include processing, by the computing system, the new online learning example with the machine-learned model to generate a prediction for the new online learning example.

In some implementations, processing, by the computing system, the new online learning example with the machine-learned model to generate the prediction for the new online learning example can include: determining, by the computing system, a total mean parameter value across all features and a total variance parameter value across all features; and determining, by the computing system, the prediction with a standard computed at an expected mean over all features normalized by a shrinkage term that equals a square root of a total variance computed over all features whose value is not 0 for the new online learning example scaled by pi over 8 and added to 1. For the probit case, this may not be necessary to scale.

In some implementations, a produced variance is an estimate of an uncertainty for the new online learning example.

In some implementations, the prediction comprises a predicted level of user interest in a content item.

Block 22 can be respectively performed for each feature for which the new online learning example has a non-zero value.

Block 22 can include determining, by the computing system, an approximate posterior for the feature conditioned on the actual outcome, wherein the approximate posterior approximates a posterior expressed as a prior of the feature multiplied by a likelihood marginalized on all other features with a self-excluding prior and normalized by the prediction, wherein the self-excluding prior comprises a marginal prior of all the other features combined together, wherein determining the approximate posterior comprises determining an updated mean parameter value for the feature and an updated variance parameter value for the feature.

In some implementations, this method can also be used in a mini-batch or batch setting, where a batch of examples is updated with the same method, instead of just a single example. In some implementations, for the batch usage, instead of updating the variance, an implementing system can update the precision (the inverse of the variance). This update can be additive (as well as the update of the mean), so the batch processing is just a sum of the single example update.

In some implementations, for each feature for which the new online learning example has a non-zero value, the self-excluding prior is computed as a single probability distribution aggregating an effect of all the other features.

In some implementations, determining the updated mean parameter value for the feature can include performing Newton's method or using any other method (e.g., including an r generalized Lambert function) to solve a mean update function to determine the updated mean parameter value, the mean update function matching a peak of a current true posterior with a peak of the approximate posterior for the feature.

In some implementations, determining the updated mean parameter value for the feature can include solving a first or higher order approximation of a mean update function to determine the updated mean parameter value, the mean update function matching a peak of a current true posterior with a peak of the approximate posterior for the feature.

In some implementations, determining the approximate posterior for the feature can include determining the updated variance parameter value that approximately matches a current true posterior with the approximate posterior for the feature, either matching value or curvature at the peak of the true posterior or by matching other signals in the posterior distribution.

In some implementations, determining the updated mean and variance parameter values for the feature can include solving a minimization matching of a current true posterior with the approximate posterior for the feature, where matching is achieved on the posterior which is attained by marginalization of likelihood and self-excluding prior of all other features.

After Block 22, method 12 can optionally return to Block 16.

### Example Devices and Systems

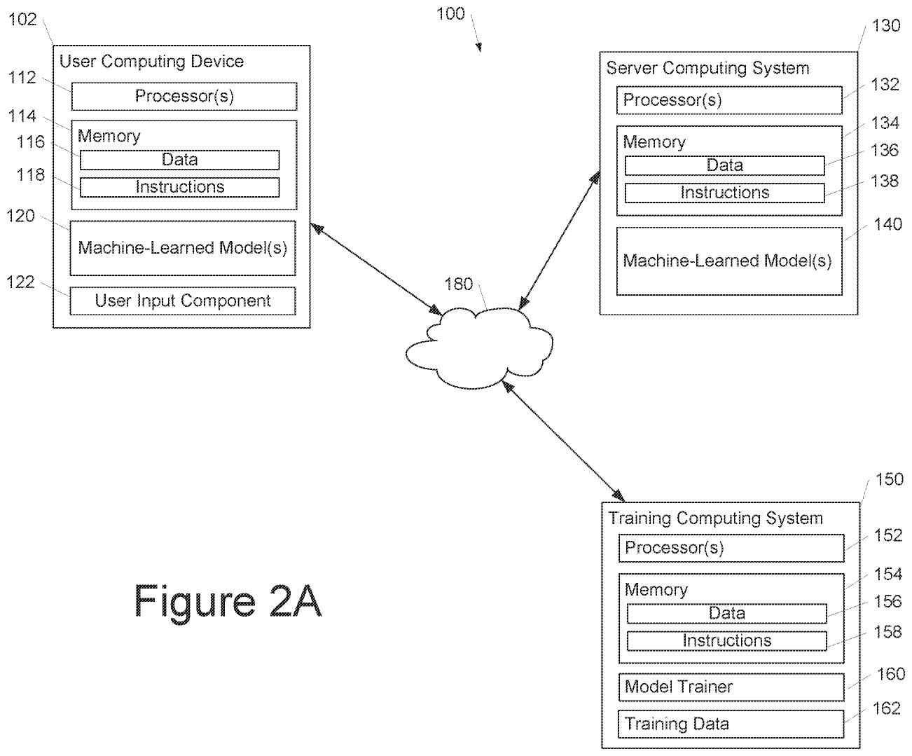

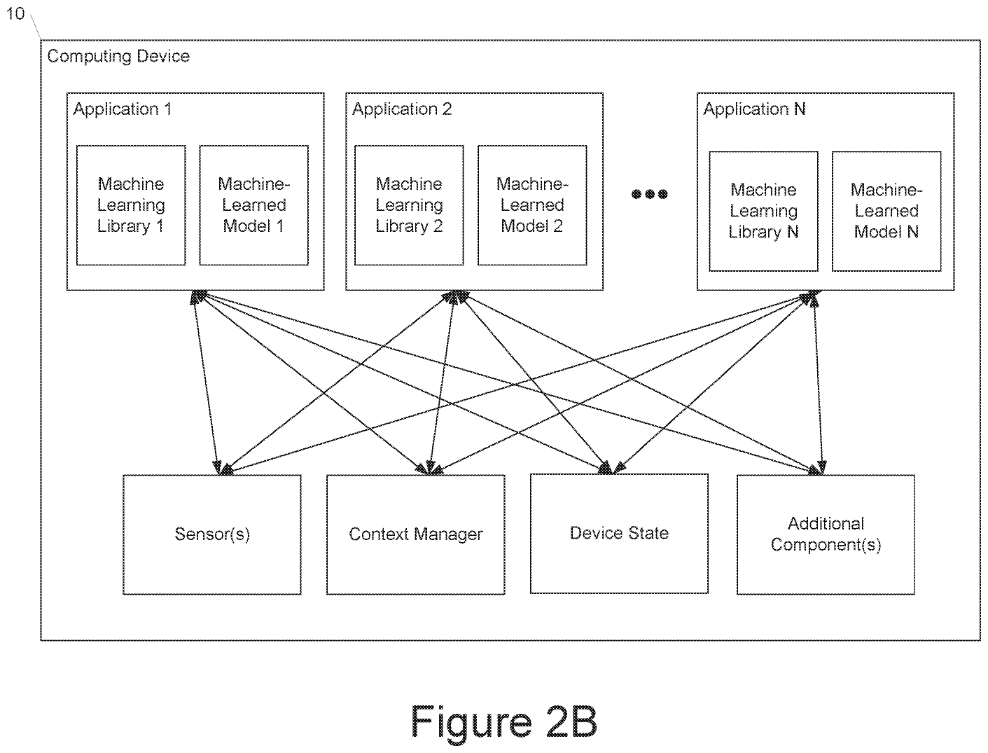

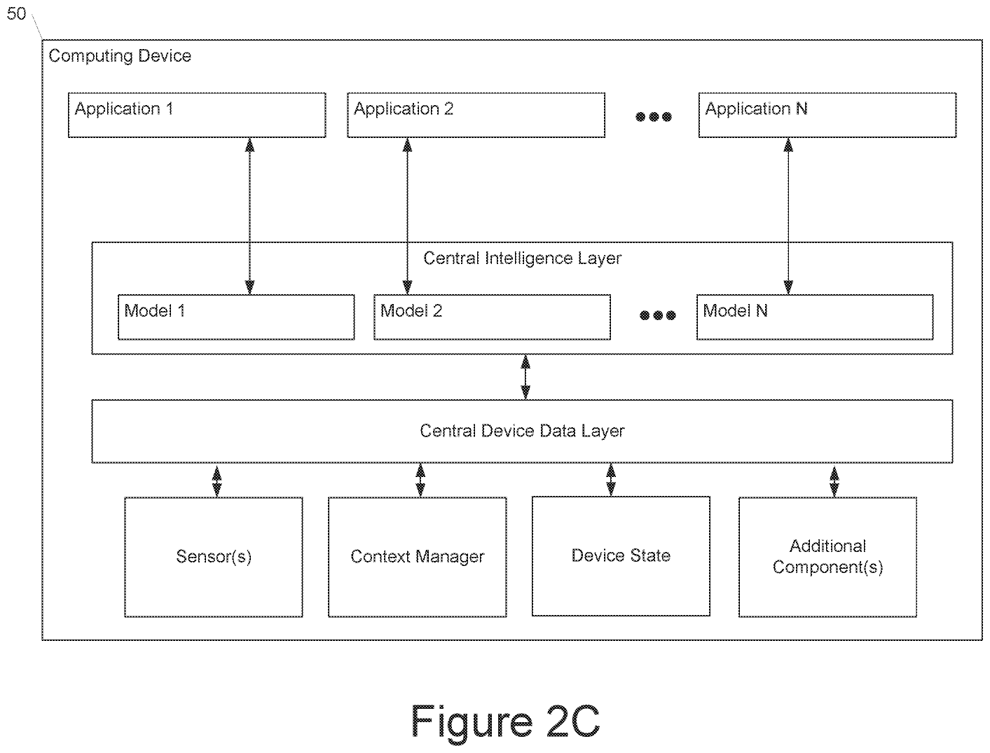

FIG. 2A depicts a block diagram of an example computing system 100 that performs Bayesian learning according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

In some implementations, the training system 150 can perform the Bayesian algorithm in this disclosure. Generally, it can replace other optimizers, but the system can also do multiple optimization tasks that also use other methods.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained. In particular, the model trainer 160 can train the machine-learned models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may comprise compressed audio data. In another example, the input includes visual data (e.g. one or more image or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API). s

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform online learning of machine learning models that is computationally efficient even with extreme numbers of features, the method comprising:
obtaining, by a computing system comprising one or more computing devices, a machine-learned model comprising a respective mean parameter value and a respective variance parameter value for each of a plurality of features; and
for each of one or more online learning examples:
receiving, by the computing system, a new online learning example having a plurality of values for the plurality of features;
processing, by the computing system, the new online learning example with the machine-learned model to generate a prediction for the new online learning example;
observing, by the computing system, an actual outcome associated with the new online learning example; and
for each feature for which the new online learning example has a non-zero value:
determining, by the computing system, an approximate posterior for the feature conditioned on the actual outcome, wherein the approximate posterior approximates a posterior expressed as a prior of the feature multiplied by a likelihood marginalized on all other features with a self-excluding prior and normalized by the prediction, wherein the self-excluding prior comprises a marginal prior of all the other features combined together, and wherein determining the approximate posterior comprises determining an updated mean parameter value for the feature and an updated variance parameter value for the feature.

2. The computer-implemented method of claim 1, wherein, for each feature for which the new online learning example has a non-zero value, the self-excluding prior is computed as a single probability distribution aggregating an effect of all the other features.

3. The computer-implemented method of claim 1, wherein determining the updated mean parameter value for the feature comprises solving a mean update function to determine the updated mean parameter value, the mean update function matching a peak of a current true posterior with a peak of the approximate posterior for the feature.

4. The computer-implemented method of claim 1, wherein determining the updated mean parameter value for the feature comprises solving a first or higher order approximation of a mean update function to determine the updated mean parameter value, the mean update function matching a peak of a current true posterior with a peak of the approximate posterior for the feature.

5. The computer-implemented method of claim 1, wherein determining the approximate posterior for the feature comprises determining the updated variance parameter value that approximately matches a current true posterior with the approximate posterior for the feature, either matching value or curvature at the peak of the true posterior.

6. The computer-implemented method of claim 1, wherein determining the updated mean and variance parameter values for the feature comprises solving a minimization matching of a current true posterior with the approximate posterior for the feature, where matching is achieved on the posterior which is attained by marginalization of likelihood and self-excluding prior of all other features.

7. The computer-implemented method of claim 1, wherein processing, by the computing system, the new online learning example with the machine-learned model to generate the prediction for the new online learning example comprises:
determining, by the computing system, a total mean parameter value across all features and a total variance parameter value across all features; and
determining, by the computing system, the prediction with a standard Gaussian Cumulative Distribution Function computed at an expected mean over all features normalized by a shrinkage term that equals a square root of a total variance computed over all features whose value is not 0 for the new online learning example scaled by pi over 8 and added to 1.

8. The computer-implemented method of claim 7, wherein a produced variance is an estimate of an uncertainty for the new online learning example.

9. The computer-implemented method of claim 1, wherein the machine-learned model comprises a binary logistic regression model or binary probit regression model.

10. The computer-implemented method of claim 1, wherein a number of the plurality of features exceeds one billion.

11. The computer-implemented method of claim 1, wherein the new online learning example is sparse in the plurality of features.

12. The computer-implemented method of claim 1, wherein the prediction comprises a predicted level of user interest in a content item.

13. A computing system configured to perform learning of machine learning models that is computationally efficient even with extreme numbers of features, the computing system comprising:
one or more processors; and
one or more non-transitory computer-readable media that collectively store instructions that, when executed by the one or more processors cause the one or more processors to perform operations, the operations comprising:
obtaining, by the computing system, a machine-learned model comprising one or more weights for each of a plurality of features; and
for each of one or more learning examples:
receiving, by the computing system, a learning example having a plurality of values for the plurality of features;
processing, by the computing system, the learning example with the machine-learned model to generate a prediction for the learning example;
accessing, by the computing system, a true label associated with the new learning example; and
for each feature for which the learning example has a non-zero value:
determining, by the computing system, an approximate posterior for the feature conditioned on the actual outcome, wherein the approximate posterior approximates a posterior expressed as a prior of the feature multiplied by a likelihood marginalized on all other features with a self-excluding prior and normalized by the prediction, wherein the self-excluding prior comprises a marginal prior of all the other features combined together, wherein determining the approximate posterior comprises determining an updated mean parameter value for the feature and an updated variance parameter value for the feature.

14. The computing system of claim 13, wherein, for each feature for which the new online learning example has a non-zero value, the self-excluding prior is computed as a single probability distribution aggregating an effect of all the other features.

15. The computing system of claim 13, wherein determining the updated mean parameter value for the feature comprises solving a mean update function to determine the updated mean parameter value, the mean update function matching a peak of a current true posterior with a peak of the approximate posterior for the feature.

16. The computing system of claim 13, wherein determining the updated mean parameter value for the feature comprises solving a first or higher order approximation of a mean update function to determine the updated mean parameter value, the mean update function matching a peak of a current true posterior with a peak of the approximate posterior for the feature.

17. The computing system of claim 13, wherein determining the approximate posterior for the feature comprises determining the updated variance parameter value that approximately matches a current true posterior with the approximate posterior for the feature, either matching value or curvature at the peak of the true posterior.

18. One or more non-transitory computer-readable media that collectively store instructions that, when executed by one or more processors cause the one or more processors to perform operations, the operations comprising:
obtaining a machine-learned model comprising a respective mean parameter value and a respective variance parameter value for each of a plurality of features; and
for each of one or more marginalized Bayesian learning iterations:
receiving a learning example having a plurality of values for the plurality of features;
processing the learning example with the machine-learned model to generate a prediction for the learning example;
accessing a true label associated with the new learning example; and
for each feature for which the learning example has a non-zero value:
determining a probability of the true label as a function of an updated mean parameter value for the feature and shrunk as a function of a self-excluding variance of the feature; and
solving a minimization of the probability of the true label to determine the updated mean parameter value for the feature and an updated variance parameter value for the feature.

19. The one or more non-transitory computer-readable media of claim 18, wherein, for each feature for which the new online learning example has a non-zero value, the self-excluding prior is computed as a single probability distribution aggregating an effect of all the other features.

20. The one or more non-transitory computer-readable media of claim 18, wherein determining the updated mean parameter value for the feature comprises solving a mean update function to determine the updated mean parameter value, the mean update function matching a peak of a current true posterior with a peak of the approximate posterior for the feature.
